(19) United States
(12) Patent Application Publication
(10) Pub. No.: US 2017/0302522 A1
(43) Pub. Date: Oct. 19, 2017

(54) METHOD AND APPARATUS FOR DYNAMIC VEHICLE COMMUNICATION RESPONSE

(71) Applicant: FORD GLOBAL TECHNOLOGIES, LLC, Dearborn, MI (US)

(72) Inventors: Basavaraj TONSHAL, Northville, MI (US); Panduranga Chary KONDOJU, Westland, MI (US); Praveen Kumar YALAVARTY, Novi, MI (US); John William SCHMOTZER, Canton, MI (US)

(21) Appl. No.: 15/098,850

(22) Filed: Apr. 14, 2016

(51) Int. Cl. H04L 12/24; H04L 29/08; H04W 84/12

(52) U.S. Cl. CPC H04L 41/0893; H04W 84/12; H04L 41/0631; H04L 67/12

(57) ABSTRACT

A system includes a vehicle processor configured to receive a query, including response network parameters, from a remote entity. The processor is also configured to determine a response transport policy based on the parameters. The processor is further configured to determine if a network having characteristics defined by the policy in conjunction with parameter values is currently connected and utilize the network, if currently available, to transmit a query response, otherwise queue the response until such a network is connected.

### TECHNICAL FIELD

The illustrative embodiments generally relate to a method and apparatus for dynamic vehicle communication response.

### BACKGROUND

Communication with a vehicle computing system from a remote source can take the form of time-sensitive and non-time-sensitive communication. Time-sensitive communication may be responded to, or may need to be responded to, to preserve usefulness of the response, in a timely manner. Non-time-sensitive communication may include, for example, without limitation, an inquiry about a vehicle system state for informational purposes. This data could be gathered in less than an immediate fashion, and still the usefulness could be preserved.

Using any available communication infrastructure can result in lost data and/or higher than expected costs. Depending on a number of factors (e.g., without limitation, data size, network usage costs, re-transmission rates, etc.), use of certain networks can increase the cost of communication with a vehicle. This may be acceptable in a time-sensitive situation, but when a query can be responded to in a non-time-sensitive manner, alternative communication strategies can be employed.

### SUMMARY

In a first illustrative embodiment, a system includes a vehicle processor configured to receive a query, including response network parameters, from a remote entity. The processor is also configured to determine a response transport policy based on the parameters. The processor is further configured to determine if a network having characteristics defined by the policy in conjunction with parameter values is currently connected and utilize the network, if currently available, to transmit a query response, otherwise queue the response until such a network is connected.

In a second illustrative embodiment, a computer-implemented method includes determining a network policy to transmit a response to a received query, the query including parameters used by a vehicle computer to determine which network policy to use based on included parameter values, the policy defining a network having characteristics matching parameter values. The method also includes utilizing the network to transmit the response if currently available and queuing the response if the network is not currently available.

In a third illustrative embodiment, a computer-implemented method includes determining a network policy to transmit a response to a received query, the query including parameters used by a vehicle computer to determine which network policy to use based on which parameters are included with the query, the policy defining a network having characteristics matching parameter values included in the query. The method also includes utilizing the network, if available, to transmit the response and queuing the response if the network is not available.

### BRIEF DESCRIPTION OF THE DRAWINGS

FIG. 1 shows an illustrative vehicle computing system; and

FIG. 2 shows an illustrative flow for responding to a non-time-sensitive communication;

FIG. 3 shows an illustrative example of a communication policy implementation;

FIG. 4 shows an illustrative example of a network state evaluation process;

FIG. 5 shows an illustrative example of transport configuration parameters defining illustrative policies; and

FIGS. 6A-6C show illustrative examples of data transmission utilizing varied communication strategies.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

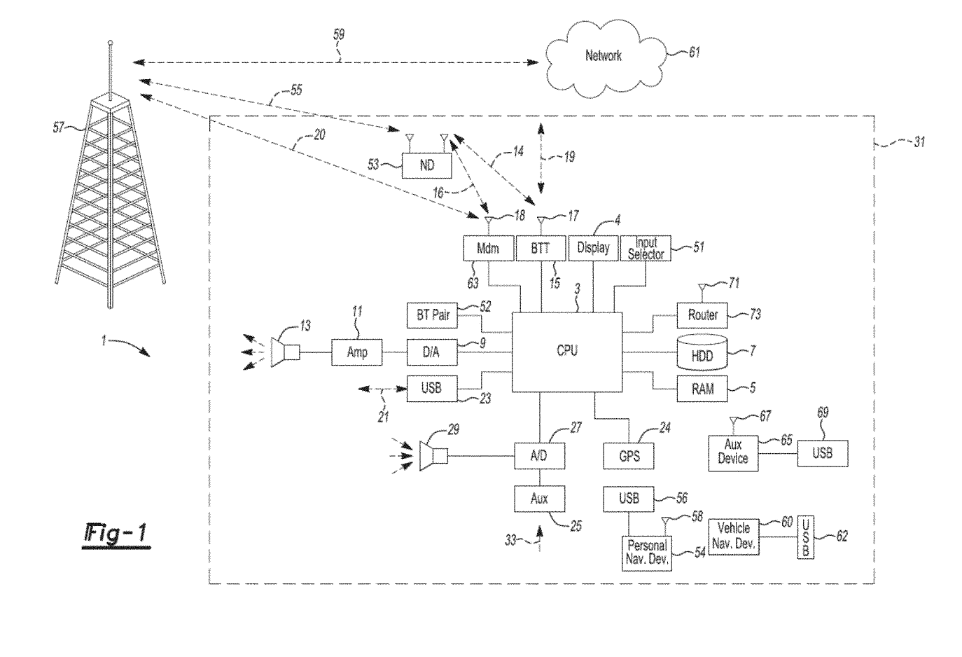

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

A vehicle-to-cloud communication protocol may be designed to provide communication between a vehicle-based computing system (VCS), such as a telematics unit of a vehicle, and a service delivery network remote from the vehicle. The protocol may define a transport layer used to send message payloads between the VCS and the service delivery network, as well as a format for the payloads of the messages that are sent.

A name/value pair model may allow for data elements of the messages to be defined that vary according to the type of message being sent. Additionally, the name/value pair model may allow for subsets of data to be defined (e.g., information to include in messages from vehicles, information to be included in messages from the service delivery network, information describing the status of the vehicle, information describing a current location of a vehicle, etc.). These subsets of data may then be reused as a component in other message definitions, without the subset of data being redefined each time.

Moreover, by use of the name/value pair model for data transmission, the system may allow for addition of data elements to the message definition, without undesirably affecting deployed message recipients that implement communication with the service delivery network utilizing a previous version of the message definition. Rather, as the data elements are addressed by identifier and not by message location, updated framework modules may be utilized without affecting existing deployed applications or vehicles compiled against a previous version of the framework. In an example, Google protocol buffers may be utilized as the payload protocol, allowing for a message definition to be designed, and automatically generated into a framework module to be utilized in various programming languages. The packing of data performed by utilizing protocol buffers may allow for more efficient transfer of data than may be possible when utilizing a textual name/value pair framework such as extensible markup language (XML).

An illustrative exemplary service delivery network may be in communication over a network with a vehicle by way of a message broker. The vehicle may be in wireless communication with the network by way of the VCS of the vehicle. When a vehicle is assembled, the vehicle may include various hardware and software components.

In existing implementations, a vehicle VCS may be configured to query for existence and version information for at least a portion of the hardware and software components of the vehicle. Using the queried information and additional information identifying the specific vehicle (e.g., vehicle identification number (VIN) information published on the controller area network (CAN) bus, subscriber identity module (SIM) information of the modem such as international mobile station equipment identity (IMEI), etc.), the VCS may communicate via the network and message broker to establish an account with the service delivery network. The service delivery network may receive these communications from the vehicles, and may maintain a data store of the hardware configurations and software (e.g., firmware, etc.) versions linked to identifiers of the vehicles.

A message broker may additionally provide publish/subscribe messaging functionality for communication between the service delivery network and the vehicles. The publish/subscribe model may utilize one or more topics, where topics are named logical channels through which publishers may send messages and subscribers may receive messages. Rather than receiving all the messages, subscribers to the topics receive the messages published to the topics to which they subscribe, and all subscribers to a topic will receive substantially the same topic messages.

In this implementation, to add a new feature, one might need to change a number of parameter sets both on the vehicle and in the cloud to enable the new feature. By using the illustrative embodiments presented herein, and similar concepts, an abstraction of vehicle data can be achieved that does not require designing an interface specifically to a vehicle architecture or specific functionality.

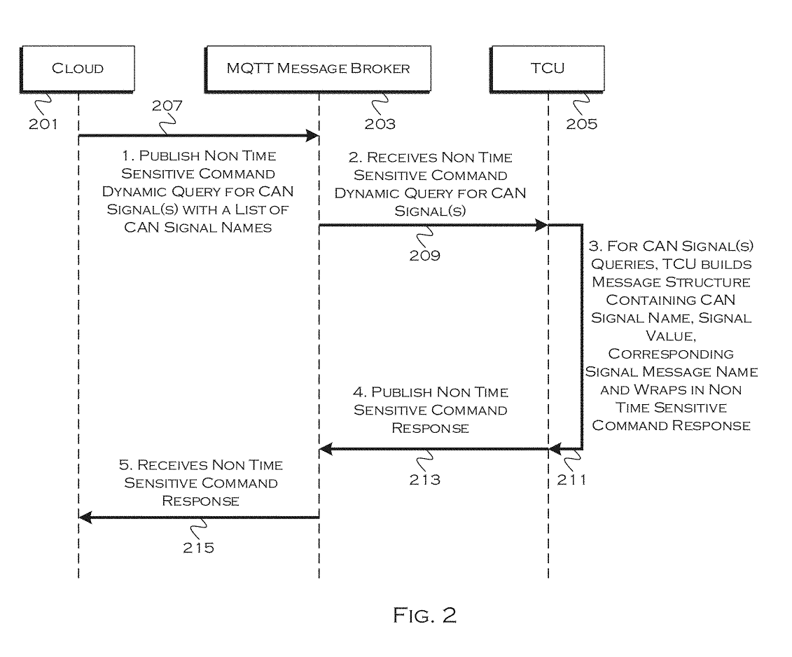

FIG. 2 shows an illustrative flow for responding to a non-time-sensitive communication. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

There are three parties to a communication process in this illustrative example. There is a cloud 201, which can include, but is not limited to, a backend network, a remote device communicating with the vehicle or any other intermediary for a remote computing system or backend process attempting vehicle communication. There is also a message queue telemetry transport (MQTT) message broker 203, which facilitates communication between the cloud and a telematics control unit (TCU) 205. The message broker is responsible for relaying messages to the appropriate entity (requesting party/entity and/or TCU). Finally, in this example, the TCU 205 handles responding to a message. In this example, the TCU is also responsible for selecting the appropriate policy for a message response and conveying the response over an accordingly appropriate channel. The TCU can perform this function in conjunction with an in-vehicle distributed connectivity manager (IVDCM). The MQTT broker may reside in the cloud, and handle communication between the TCU/IVDCM and a backend entity.

In this illustrative example, the cloud publishes a non-time-sensitive command, which can include a dynamic query for controller area network (CAN) signals, including a list of CAN signal names that are of interest to the query 207. The message broker receives the query and relays the query 209 to an appropriate module executing on the TCU to handle the request. This message/query may include a particular policy that should apply to a response and/or define a set of parameters for the response that can be used to determine which policy should be used.

The appropriate TCU module then receives the query and builds a response, including signal names, signal values, signal message names, etc 211. This response is wrapped as a non-time-sensitive command response and passed back to the message broker for response 213. The TCU can determine, based on a defined policy, which available or desirable communication channels are suitable for transmission of the message. Once a suitable channel is available/connected, the message broker receives the response and can pass back the query response to the requesting entity 215.

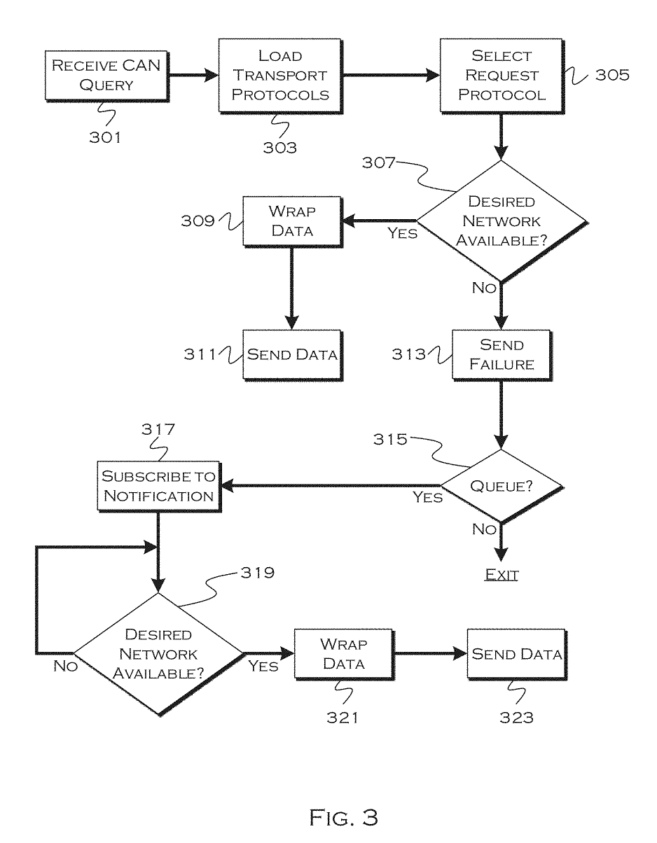

FIG. 3 shows an illustrative example of a communication policy implementation. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process receives a message for response, such as a CAN query 301. Different message types may receive different responses (with regards to utilized networks), so the process then loads or accesses a set of transport protocols (policies) 303. A particular policy is selected for the response based on the nature of the message to which the response is given 305.

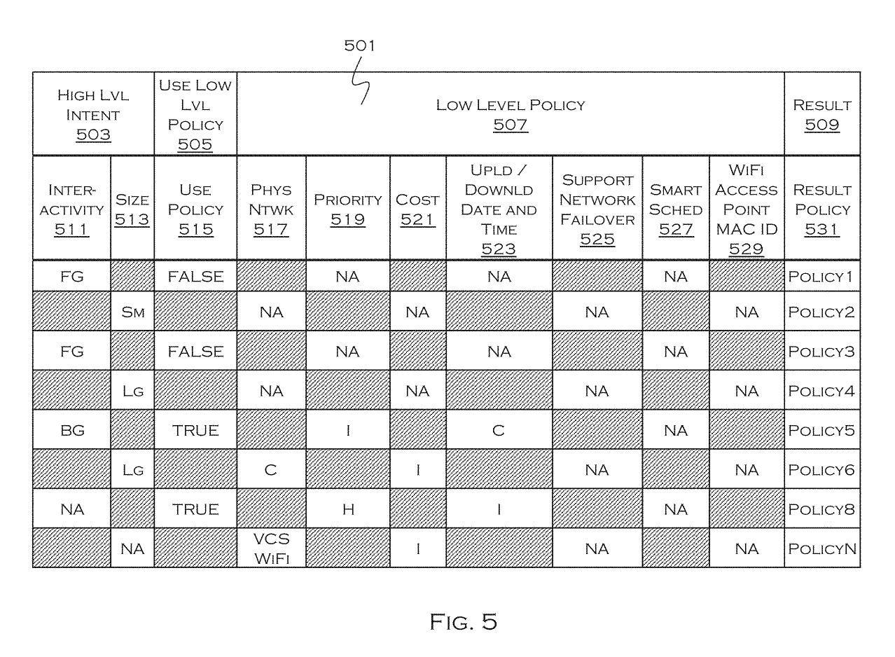

As will be seen in FIG. 5, the policies define one or more suitable communication networks for use in responding to a given message. If a network corresponding to a permissible network as defined by the policy is available 307, the process will wrap the data for response 309 and send the data 311 using the network identified based on the selected policy.

On the other hand, if the desired network is not available, or if no network meeting parameters defined by the policy is available, the process can send a failure notification immediately 313. This lets the requesting entity know that the response could not be immediately handled using a policy chosen for the response. This does not necessarily mean that no response will be provided, just that one cannot be provided at this time.

Certain messages can be responded to at a later time, and if appropriate, the process will queue the response for later delivery 315. Since the response is not delivered, in this example, based on a lack of a suitable network connection, the process subscribes to a notification process 317 that will allow the process to know when a suitable network becomes available. This could be due to, for example, connection to a new network or a change in signal strength of an existing network. Other changes to network characteristics may also cause a currently connected, but unsuitable network, to transition into a network suitable for response delivery.

Once a network exhibiting the characteristics defined by the policy as desirable for response is available 319, the process can wrap the data 321 and send the data 323 using the suitable network. In the illustrative examples, the IVDCM (which resides on the vehicle) is responsible for selecting the appropriate network for communication based on the policy devised from the parameters included in the initial message received from the MQTT (to which a response is being sent).

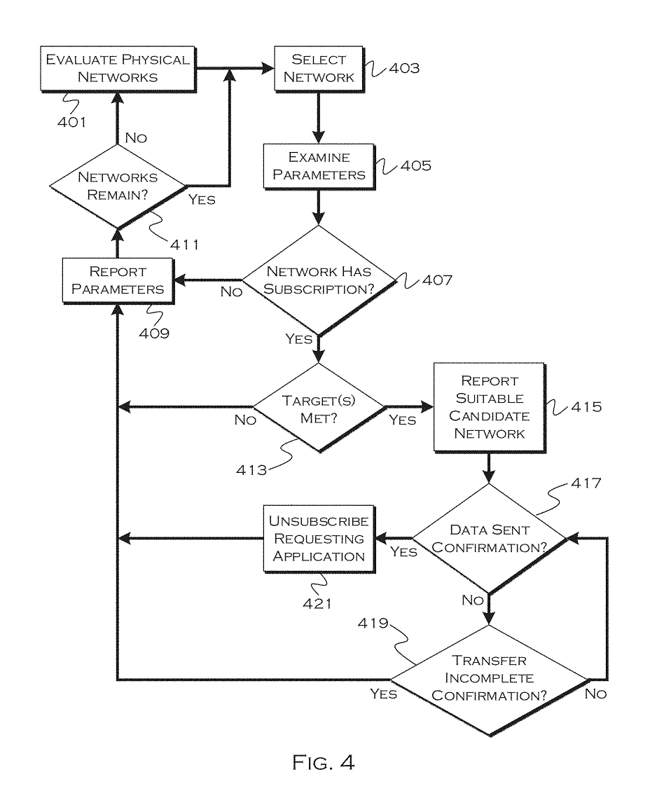

FIG. 4 shows an illustrative example of a network state evaluation process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process will evaluate all connected networks to establish a set of characteristics for each connected network. These characteristics can be compared to parameters defined by a policy for a given response, to determine if a particular network is suitable for use in transmitting the response. This is not to say that a particular network could not be used to transmit a response, but rather that a policy selected for the response may defined characteristics of a desirable network for the particular response, and the TCU may delay response until such time as a policy-compliant network is available.

The process will evaluate all of the physical networks connected to the vehicle 401, and determine the policy characteristics of each network. A given network is selected for evaluation 403, and the process examines the particular characteristics of the network 405. These characteristics can include, but are not limited to, latency, bandwidth, a particular network type, priority, cost-paying entity (who pays for data), projected transmission time, etc. A specific network can be defined based on MAC ID for certain communications.

Once the process has completed evaluating the network, the process will determine if there are any subscriptions for information pertaining to the particular network 407. Since some policies define a network of a certain type or even a specific network of a certain type by MAC address, there may be subscriptions generated relating to pending message responses for certain network types. Subscriptions may also be more generalized—for example, a subscription could be for a high bandwidth network that is paid for by the customer.

If the network has subscriptions, or if there is a subscription to a topic that corresponds to characteristics of the network (such as the high bandwidth, customer-paid network topic previously noted as an example), the process can respond to the subscribing entity. Otherwise, the process can store the characteristics of the network 409 for retrieval by later policy requests and proceed to evaluate a next-network. Since the characteristics of networks may change over time, and since new networks may be added or dropped constantly, this process can run in the background and/or periodically while a vehicle is in use.

If there is one or more entities subscribing to a particular topic that corresponds to a network or a set of characteristics, the process may determine if the desired parameters specified by the entity are met 413. In another example, the process may report all characteristics of the network to the subscribing entity, and the entity can determine if the network is suitable. Here, if the desired characteristics are met, the process reports the network as a transmission candidate network 415.

Since subscriptions can be dynamically created as needed by a policy associated with a given pending response, the subscriptions can be specific enough to cover all possible characteristics of a given network. In such a model, the response to the subscribing entity would “automatically” identify the reported network as a candidate network. In other models, a subscribing entity may subscribe to certain “necessary” parameters, and then evaluate all characteristics of reported networks to determine a suitable candidate. For example, if there are preferred but optional characteristics of networks, the requesting system may receive several candidate networks corresponding to the core subscription topic (e.g., wifi) and then determine which of those networks has the best set of optional characteristics.

Also, in this example, the process handles subscription management. Thus, after reporting the candidate network 415, the process waits for a confirmation that the desired data has been sent. This sub-process can also spool in the background so that additional candidate networks can be reported. If no data transmission confirmation is received, such as, for example, if a transfer incomplete notification is received due to a failure 419, the process can simply record the network characteristics and determine if any networks remain for evaluation 411. If a notification that the transfer is successful is received, the process can unsubscribe the requesting entity/application from the particular subscription 421, since the corresponding response for which the subscription was created has been completed.

FIG. 5 shows an illustrative example of transport configuration parameters usable to select a particular policy. This is not an exhaustive list of parameters, but demonstrates some possible considerations that may be correspond to particular policies associated with varied types of responses.

An interactivity level 511 associated with a response defines whether a response is a foreground or background response. For this and a number of other parameters, there are many policies that ignore the particular consideration, shown as not applicable (NA) in the example. A size 513 consideration dictates whether latency (small) or bandwidth (large) network is a primary concern (given the availability of multiple networks). Together, interactivity and size define a set of high-level intent policies used for certain communication types.

For communications other than those dictated by the high level intent parameters, low level policy parameters may be used 515. If a request dictates that low level policies are to be used, a variety of other parameters may dictate which policy is used. In this illustrative example, the message request either defines a set of parameters for consideration or is characterizable as a message of a certain type, for which response parameters have already been defined.

The physical network parameter 517 defines a specified network that may be included with a response definition or included as a parameter with the message request. In some policies, this network “must” be used (i.e., it is used if available, and waited-for if not available). In other policies, the network is simply preferred, and it is not available then another reasonable candidate network will be chosen.

Priority 517 defines a response priority, usable if multiple responses are requesting the same communication network. A higher priority response can be given transport preference over another response having lower priority. Priority can also dictate whether a specified network (conforming to the policy) should be used or if a best-available network should be used. For example, as will be seen in the exemplary policy descriptions listed herein, high priority message responses are preferred for certain networks according to certain policies, but if a preferred network is not available, a next-best network is chosen. Medium and low priority messages are delayed until such time as an appropriate network is available.

The cost parameter 521 dictates whether or not which entity that pays for the transmission of data should be considered. Examples include, but are not limited to, NA/Ignore (cost irrelevant), OEM_PAID (cost paid by manufacturer), CUSTOMER_PAID (cost paid by customer), FREE, etc. Since some requests may be made by an OEM and have little or nothing to do with a customer experience, it may not be appropriate for a customer-paid network to be used for these responses. On the other hand, explicit customer requests for certain data are appropriate for routing through a customer-paid network and avoiding use of an OEM-paid network.

A response data/time 527 may also be considered in selecting some of the policies. This can include a consideration of whether a network is available or likely to be available at a preferred time/date. Certain responses may also support network failover 525, which is the selection of an alternative network if a preferred network transmission fails for some reason.

Smart scheduling 527 is associated with a single policy in this example. Smart scheduling allows scheduling of the response based on known network coverage maps and a vehicle location, among other things (e.g., the response can be scheduled for a time when a vehicle is projected to be at a certain location with certain known coverage).

A MAC ID can be specified for certain messages as well 529, dictating a specific wifi access point to be used for message transmission. The result of all these considerations is a policy selection 531, which dictates which network to use (meeting certain parameters) and criteria for selection. Several examples of the policies follow:

Policy A—Priority: High; Rule—If multiple networks are available, evaluate and choose the one with the least latency.

Policy B—Priority: Medium; Rule—Select the physical network as specified in Low level policy. If the specified physical network is not available wait for the network availability.

Policy C—Priority: High; Rule—Select the physical network as specified in Low level policy as Wi-Fi access point with MAC id. If the specified Wi-Fi access point is not available then evaluate the available networks and choose the one with least latency.

As can be seen from the illustrative policy examples, with respect to high priority policies (in this example, for illustration only), a certain network is defined as preferred by one or more parameters, and then a secondary consideration is made with respect to available networks if the preferred network is unavailable. With respect to the low and medium priority transmissions, a network of specified parameters is waited-for if currently unavailable.

Policies A in this example is different, being a high level intent policies that ignores low level parameters. This transmission is made based on any available network, with preference given to a certain network characteristic based on a particular policy. In these four policies, even the low and medium level priority responses are sent on any available network.

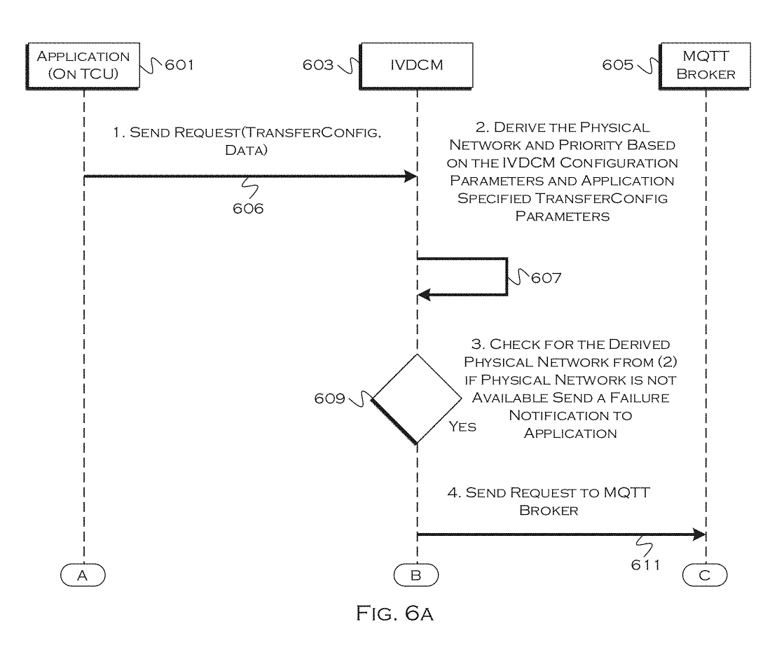

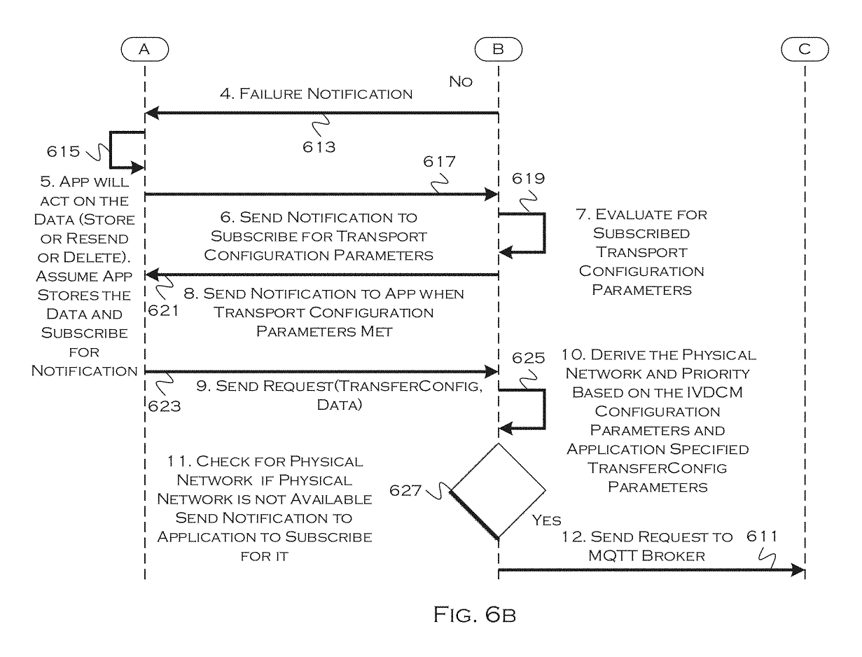

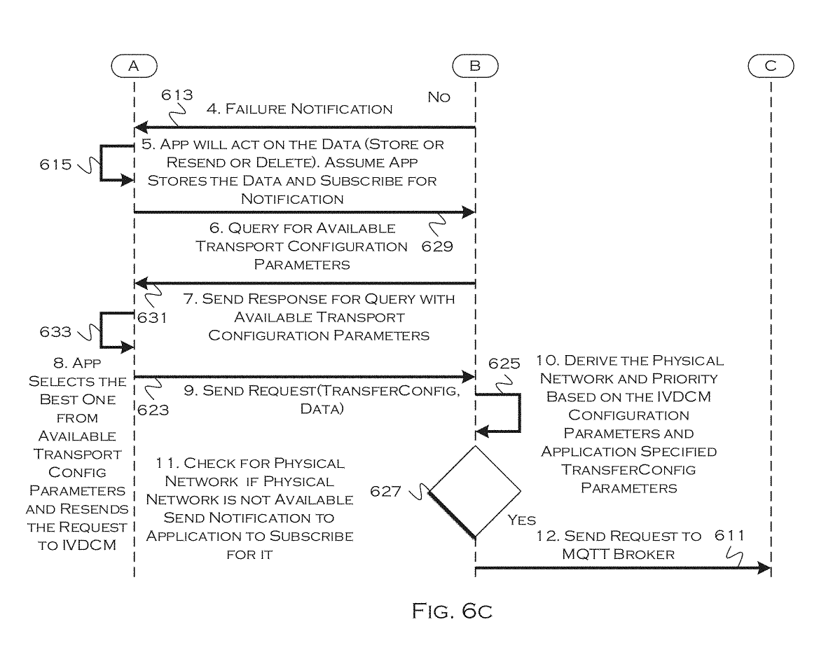

FIGS. 6A-6C show illustrative examples of data transmission utilizing varied communication strategies. With respect to the illustrative embodiments described in these figures, it is noted that a general purpose processor may be temporarily enabled as a special purpose processor for the purpose of executing some or all of the exemplary methods shown herein. When executing code providing instructions to perform some or all steps of the methods, the processor may be temporarily repurposed as a special purpose processor, until such time as a method is completed. In another example, to the extent appropriate, firmware acting in accordance with a preconfigured processor may cause the processor to act as a special purpose processor provided for the purpose of performing the methods or some reasonable variations thereof.

In the illustrative example shown in FIG. 6A, an application residing on the TCU 601 sends a request 606 including transfer configuration parameters (response parameters) and the data for the response. An in-vehicle distributed connectivity manager (IVDCM) 603 determines, based on the assigned response parameters and the IVDCM configuration, which physical network to use for the response 607. If the physical network is available 609, a request 611 is sent to the MQTT broker 605 requesting response transmission. If the selected network (or a fall-back network) is not available, the IVDCM can report a response failure to the requesting application.

FIG. 6B shows a more expanded process than that of FIG. 6A, which, in this example, allows the application to subscribe to a topic corresponding to relevant transport parameters. When a network meeting the desired parameter(s) is available, the application can re-transmit the response for final transmission.

In this process, the application 601 sends a request 606 as in FIG. 6A. The IVDCM will select a network as before 607, and will check for a network that meets the policy constraints. If the network is available, the transmission 611 to the MQTT broker 605 proceeds as in FIG. 6A.

If the network is not available, however, the application will take further action upon receipt of the failure notification 613. The application stores the response data (if appropriate for the particular response) 615 and selects (based on the policy) a consideration for a desired network. A subscription to the IVDCM is established based on this network constraint 617. For example the subscription might be to identification of a customer paid network. Any number of networks may become available over a drive, and if any are customer paid a response 621 could be sent to the application. It may also be the case that free networks are acceptable under this policy, so another subscription to free networks could be established. The IVDCM will evaluate networks as they become available 619, and if any meet the subscription parameters the appropriate response can be sent identifying the network.

Once the appropriate network has been identified as being available, the application can re-send the request 623. The IVDCM can then select the identified network as appropriate for the transmission 625. Since the network may have become unavailable, the process can also re-enact the subscription process 627 if the network has suddenly become unavailable. Otherwise, the selected network can be used to send the response to the MQTT broker 611. This illustrative process is useful if, for example, no transmission is desired unless a specified network of certain parameters is available.

FIG. 6C shows an illustrative example of a process similar to that of FIG. 6B. This illustrative process is useful if a policy dictates that a secondary network is to be used if a preferred network is not available (such as for high priority transmissions in the illustrative examples).

In this illustrative example, the application 601 again sends 606 the initial request specifying certain network preferences and a data payload. The IVDCM 603 will attempt to select the appropriate connected physical network 607 for transmission of the request to the MQTT broker 605.

If the network is unavailable, a failure notification can be sent 613 to the application. In this example, the application does not simply wait for a desired network to become available, but instead attempts to utilize a secondary network for transmission. Accordingly, the application sends a query 629 as to the configuration parameters of networks that are currently available. A response from the IVDCM identifies the available networks and their particular parameters 631.

The application then selects a network from the available networks. Or, more particularly in this example, the configuration parameters of each network have been returned to the application, and the application selects the most desired set of configuration parameters 633 or a particular important parameter. The configuration parameters returned with the retransmission of the request 623 can then be tailored to match the available parameters, which will hopefully result in the selection of the appropriate network.

The IVDCM receives the re-transmission and selects the physical network meeting the new parameters 625. Again, if the network becomes unavailable, the query process may repeat or a subscription to a preferred network and/or the secondary network may be generated 627. Otherwise the request is forwarded to the MQTT broker 611 using the selected network.

Through use of the dynamic response structuring, new queries simply need to dictate policy constraints to structure responses thereto. This can ensure that appropriate transport considerations are made for the inclusion of new queries and response data, without having to reconfigure a particular module or application residing on the vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a vehicle processor configured to:
receive a query, including response network parameters, from a remote entity;
determine a response transport policy based on the parameters;
determine if a network having characteristics defined by the policy in conjunction with parameter values is currently connected; and
utilize the network, if currently available, to transmit a query response, otherwise queue the response until such a network is connected.

2. The system of claim 1, wherein the processor is configured to:
subscribe to a notification topic relating to one or more network characteristics if the network having characteristics defined by the policy is not available; and
receive a response, based on the subscription, when a network having characteristics corresponding to the one or more characteristics relating to the notification topic is connected.

3. The system of claim 1, wherein policies applicable to queries of a first priority as defined by the query identify a preferred network defined by the policy and a secondary network to be used if the preferred network is not available.

4. The system of claim 1, wherein policies applicable to queries having associated high-level intent response-network parameter values, defined by the query, dictate selection of a preferred network, defined by the policy in conjunction with parameter values, if available, and selection of any-available secondary network if the preferred network is not available.

5. The system of claim 4, wherein the high-level intent parameter values include a parameter dictating selection of a high-bandwidth network.

6. The system of claim 4, wherein the high-level intent parameter values include a parameter dictating selection of a low-latency network.

7. The system of claim 1, wherein the parameter values include specification of a particular network transport-type.

8. The system of claim 1, wherein the parameter values include specification of an entity paying a cost for network transmission.

9. The system of claim 1, wherein the parameter values include specification of a particular date and time for response.

10. The system of claim 1, wherein the parameter values include specification of a Wi-Fi access point MAC ID defining a specific Wi-Fi network to be used in transmitting the response.

11. A computer-implemented method comprising:
determining a network policy to transmit a response to a received query, the query including parameters used by a vehicle computer to determine which network policy to use based on included parameter values, the policy defining a network having characteristics matching parameter values;
utilizing the network to transmit the response if currently available; and
queuing the response if the network is not currently available.

12. The method of claim 11, wherein the parameters include network transport-type preference.

13. The method of claim 11, wherein the parameters include specification of an entity paying a cost for network transmission.

14. The method of claim 11, wherein the parameters include specification of a particular date and time for response.

15. The method of claim 11, wherein the parameters include specification of a Wi-Fi access point MAC ID defining a specific Wi-Fi network to be used in transmitting the response.

16. The method of claim 11, further comprising:
determining a secondary network, defined by the determined policy, for use prior to queuing if the initial network defined by the policy is not available.

17. The method of claim 16, wherein the policy defines the secondary network as any-available network.

18. The method of claim 17, wherein the parameter values include at least a high-level intent parameter value.

19. The method of claim 18, wherein the high-level intent parameter value is at least one of either a latency preference or a bandwidth preference.

20. A computer-implemented method comprising:
determining a network policy to transmit a response to a received query, the query including parameters used by a vehicle computer to determine which network policy to use based on which parameters are included with the query, the policy defining a network having characteristics matching parameter values included in the query;
utilizing the network, if available, to transmit the response; and
queuing the response if the network is not available.
